(19) United States
(12) Patent Application Publication
(10) Pub. No.: US 2013/0102186 A1
(43) Pub. Date: Apr. 25, 2013

(54) POWER STRIP

(71) Applicants: LI-REN FU, Shenzhen City (CN); WEN-SEN HU, Shenzhen City (CN)

(72) Inventors: LI-REN FU, Shenzhen City (CN); WEN-SEN HU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/281,455

(22) Filed: Oct. 26, 2011

(30) Foreign Application Priority Data
Oct. 21, 2011 (CN) 201110322682.4

(51) Int. Cl. H01R 13/72

(52) U.S. Cl. 439/501

(57) ABSTRACT

A power strip includes a main body, a reel, a power line, and a power cord, and a plug. The main body includes a top wall defining an outlet, a bottom wall, and a first and a second sidewalls. A pole perpendicularly extends from the bottom wall adjacent to the first sidewall. A first conductive portion electrically connected to the power line extends from the pole toward the second sidewall. The reel includes a core positioned between the first and second sidewalls and rotatably mounted to the second sidewall, and a second conductive portion mounted to the core and rotatably connected to the first conductive portion. The power cord is electrically connected to the first conductive portion.

### BACKGROUND

1. Technical Field

The present disclosure relates to a power strip.

2. Description of Related Art

Lengths of power cords of power strips are generally fixed. As a result, when the power cord of a power strip is not long enough, a new power strip having a longer power cord is needed, which is inconvenient and costly. Contrarily, when the power cord of the power strip is too long, it is often entangled with other things.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of a power strip, wherein the power strip includes a reel.

FIG. 2 is an exploded, isometric view of the reel of FIG. 1.

FIG. 3 is a cross-sectional view of FIG. 1, taken along the line of III-III.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

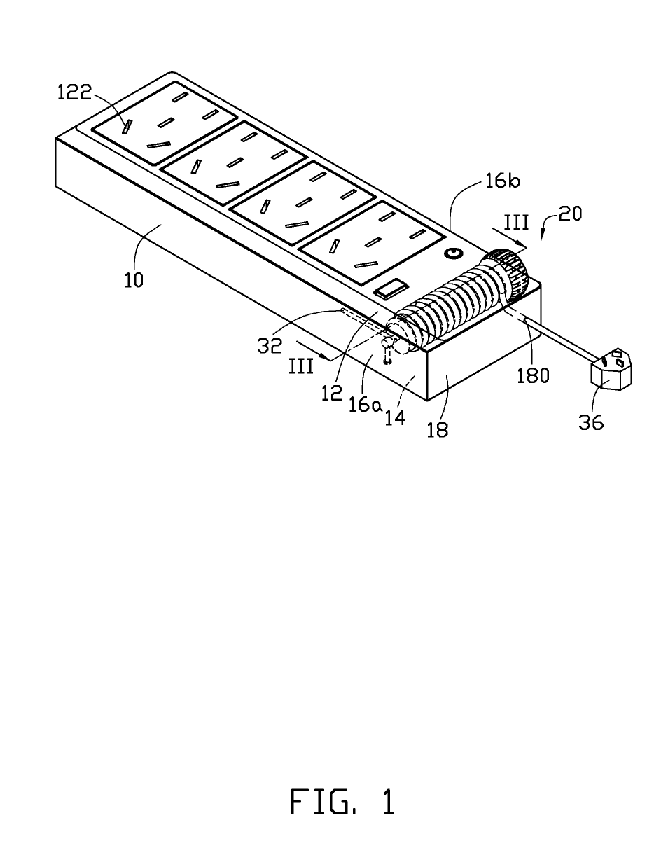

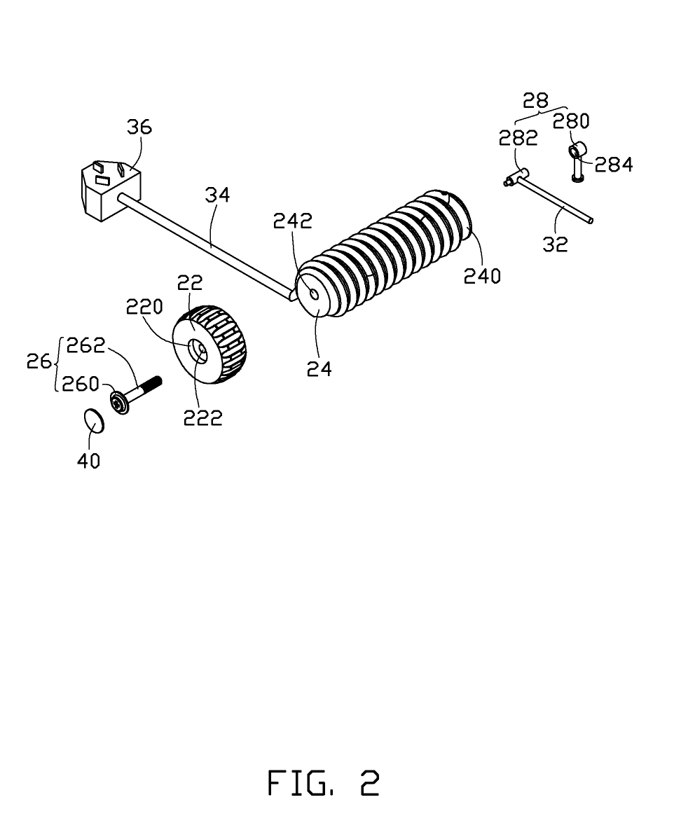

Referring to FIGS. 1 and 2, an exemplary embodiment of a power strip includes a main body 10, a built-in extension reel 20 mounted in a rear end of the main body 10, a transfer member 28, a power line 32, and a power cord 34.

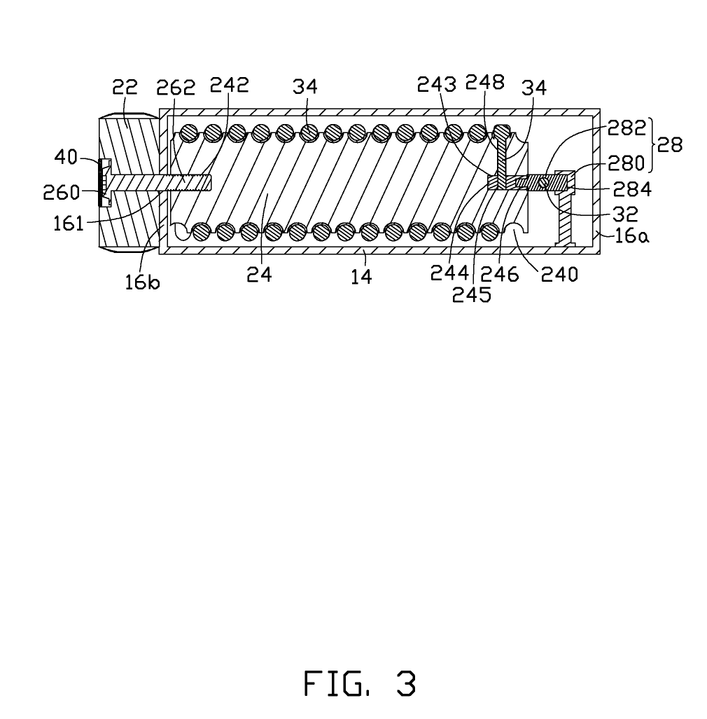

The main body 10 includes a top wall 12, a bottom wall 14, two sidewalls 16a and 16b perpendicularly connected between opposite sides of the top and bottom walls 12 and 14, and an end wall 18 perpendicularly connected between rear ends of the top and bottom walls 12 and 14. The sidewall 16b defines a through hole 161 (shown in FIG. 3) adjacent to the end wall 18. The end wall 18 defines a through hole 18 adjacent to the through hole 161. A plurality of sockets 122 is defined in the top wall 12, for outputting power.

Referring to FIG. 3, the reel 20 includes an operation portion 22, a core 24 and a fastener 26. The operation portion 22 is substantially wheel shaped, and defines a depressed portion 220 in a first side of the operation portion 22 and a through hole 222 extending through the bottom wall of the depressed portion 220 and a second side of the operation portion 22 opposite to the first side. The core 24 defines a spiral slot 240 in the circumference, and axially defines a threaded hole 242 and a receiving hole 243 in opposite ends. A through hole 248 is defined in the circumference of the core 24 adjacent to an end of the core 24 and communicating with the slot 240 and the receiving hole 243. The receiving hole 243 receives a first conductive portion 244 which axially defines a fixing hole 246 in an outer end and radically defines a connection hole 245 communicating with the through hole 248. The fastener 26 includes a head 260 and a threaded pole 262 perpendicularly extending from a side of the head 260.

The transfer member 28 includes a pole 280 and a second conductive portion 282. The pole 280 radically defines a fixing hole 284 in a top end of the pole 280.

The power line 32 is connected between the second conductive portion 282 and electrical elements in the main body 10. The electrical elements can be connected to a plug which is plugged in any socket 122. The power cord 34 includes a plug 36 at a first end.

Referring to FIG. 3, in assembly, a bottom end of the pole 280 is fixed to the bottom wall 14 adjacent to the sidewall 16a at the rear end. A first end of the second conductive portion 282 is engaged in the fixing hole 284. A second end of the second conductive portion 282 is rotatably received in the fixing hole 246 and electrically connected to the first conductive portion 244. A second end of the power cord 34 is extended through the through hole 180 and is received in the slot 240 to be wound on the core 24. The second end of the power cord 34 is extended through the through hole 248, and is engaged in the connection hole 245 to be electrically connected to the first conductive portion 244. Therefore, the power cord 34 is electrically connected to the power line 32 through the first and second conductive portions 244 and 282. The threaded pole 262 is extended through the through holes 222 and 161, and is then screwed into the threaded hole 242. Therefore, the core 24 is fixed to the operation portion 22, and is rotatable with the operation portion 22. The head 260 is received in the depressed portion 220. A decorative piece 40 is attached to the head 260 to cover the depressed portion 220.

In use, the plug 36 is pulled away from the main body 10 to rotate the operation portion 22 and the core 24 to extend the power cord 34. When needed, the operation portion 22 can be rotated away from the plug 36 to reel in the power cord 34.

In this embodiment, the first and second conductive portions 244 and 282 are made of copper.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A power strip, comprising:
a main body comprising a top wall defining at least one socket, a bottom wall opposite to the top wall, and a first and a second sidewalls connected between corresponding sides of the top and bottom walls, a pole extending up from the bottom wall adjacent to the first sidewall, a first conductive portion extending from the pole toward the second sidewall;
a power line comprising a first end electrically connected to the first conductive portion, and a second end connected to the at least one socket;
a power cord comprising a plug at a first end; and
a reel comprising a core accommodated between the first and second sidewalls and rotatably mounted to the second sidewall for coiling up the power cord, and a second conductive portion mounted to the core and rotatably connected to the first conductive portion, the second conductive portion electrically connected to a second end of the power cord.

2. The power strip of claim 1, wherein the second conductive portion axially defines a fixing hole for rotatably receiving the first conductive portion.

3. The power strip of claim 1, wherein the core defines a spiral slot in the circumference.

4. The power strip of claim 3, wherein the core axially defines a receiving hole for receiving the second conductive portion and a through hole communicating with the receiving hole and the slot, the second conductive portion defines a connection hole, the second end of the power cord is extended through the through hole and is engaged in the connection hole to be electrically connected to the second conductive portion.

5. The power strip of claim 1, wherein the first and second conductive portions are made of copper.

6. The power strip of claim 1, wherein the main body further comprises an end wall connected between rear ends of the top and bottom walls and defining a through hole for the power cord extending through.

7. The power strip of claim 1, wherein the reel further comprises an operation portion located outside the second sidewall and fixed to the core, the operation portion is rotatable with the core.

8. The power strip of claim 7, wherein the reel further comprises a fastener comprising a head and a threaded pole extending from a side of the head, the operation portion defines a through hole extending through opposite sides, the threaded pole is extended through the through hole of the operation portion and the second sidewall and is engaged in the core.
